(19) United States
(12) Patent Application Publication
(10) Pub. No.: US 2026/0235460 A1
(43) Pub. Date: Aug. 13, 2026

(54) ULTRA-THIN FULL-FRAME HIGH-TEMPERATURE-RESISTANT SEMICONDUCTOR STRAIN GAUGE AND PREPARATION METHOD THEREFOR

(71) Applicant: GUANGDONG RUNYU SENSOR CO., LTD, Jiangmen, Guangdong (CN)

(72) Inventors: Shucheng LI, Jiangmen, Guangdong (CN); Shaoqun SHEN, Jiangmen, Guangdong (CN); Haiquan LI, Jiangmen, Guangdong (CN); Minru LIANG, Jiangmen, Guangdong (CN)

(21) Appl. No.: 19/147,360

(22) PCT Filed: Apr. 28, 2024
(86) PCT No.: PCT/CN2024/090285

§ 371 Date: Mar. 16, 2026

(30) Foreign Application Priority Data
May 12, 2023 (CN) 202310532191.5

(51) Int. Cl. G01L 1/22

(52) U.S. Cl. CPC G01L 1/2293; G01L 1/2262

(57) ABSTRACT

The invention belongs to the technical field of pressure sensors, and more specifically, relates to an ultra-thin full-frame high-temperature resistant semiconductor strain gauge and its preparation method. The strain gauge with the full-frame closed hole structure comprises two resistance grids and three aluminum pressure feet; each of the two resistance grid is formed by four force sensitive resistances connected in series; the force sensitive resistance comprises a sub-nanocrystalline silicon thin film grown on the surface of a silicon dioxide oxide layer by low-pressure chemical vapor deposition (LPCVD), wherein the crystal nucleus size of the sub-nanocrystalline silicon thin film is between that of nanocrystalline silicon and polycrystalline silicon. The strain gauge obtained by the invention exhibits a wide application temperature range, such as an operating temperature from −60° C. to +180° C., and possesses low temperature drift characteristics and high stability.

### TECHNICAL FIELD

The invention belongs to the technical field of pressure sensors, and more specifically, relates to an ultra-thin full-frame high-temperature resistant semiconductor strain gauge and its preparation method.

### BACKGROUND ART

In the field of pressure sensors ranging from 3 MPa to 200 MPa, the contradiction in pressure sealing encapsulation structures is prominent. Conventional rubber ring seals can no longer meet the requirements for applications under high temperature and pressure, making it difficult to solve pressure leakage problems. Currently, there are two structural forms for large-range pressure sensors/transmitters domestically and internationally: one is the sputtered thin-film structure, and the other is the glass micro-fused strain gauge structure. The manufacturing process for sputtered thin-film pressure sensors/transmitters is complex, has high process requirements, and lacks cost advantages. In contrast, glass micro-fusion technology is easier to implement for mass production, offers the same reliability and stability, and has lower costs. Glass micro-fusion technology involves sintering two semiconductor strain gauges onto a 17-4PH stainless steel pressure pedestal using glass frit to form a Wheatstone bridge. The pressure pedestal is then welded onto the pressure port of a stainless steel housing using processes such as argon arc welding, electron beam, or high-energy laser beam. When pressure acts on the elastic membrane area on the back of the pressure pedestal, the Wheatstone bridge formed by the two strain gauges generates an electrical signal linearly related to the stress. This electrical signal is processed and amplified by the transmitter circuit, sent to the computer's central processor, and then commands various actions via actuators to achieve intelligent measurement and control.

Early production of glass micro-fused sensors/transmitters relied entirely on imported strain gauges. In 2015, a subsidiary of our company successfully developed a semiconductor strain gauge and applied for an invention patent (Publication No.: CN105091730B, “A DSOI Strain Gauge”). This semiconductor strain gauge, with independent intellectual property rights, can achieve an annual output of 10 million pieces and has been widely used in the production of various sensor and transmitter products.

With the expansion of application fields and in response to market demands, inventing novel semiconductor strain gauges suitable for a wide application temperature range (e.g., operating temperature −60° C. to +180° C.), featuring low temperature drift and high stability, has become an urgent problem to solve.

### SUMMARY OF THE INVENTION

The invention provides a novel semiconductor strain gauge suitable for a wide application temperature range, such as an operating temperature from −60° C. to +180° C., and possessing low temperature drift characteristics and high stability.

The purpose of the invention is to provide an ultra-thin full-frame high-temperature resistant semiconductor strain gauge.

Another purpose of the invention is to provide a method for preparing an ultra-thin full-frame high-temperature resistant semiconductor strain gauge.

The purpose of the invention is achieved by the following technical solutions.

An ultra-thin full-frame high-temperature resistant semiconductor strain gauge, wherein the strain gauge adopts a full-frame closed hole structure and comprises a high-resistance silicon substrate layer, a silicon dioxide oxide layer, two resistance grids, three aluminum pressure feet, and a silicon nitride insulating passivation film;
the two resistance grids are interconnected to form a half-bridge Wheatstone measurement circuit, each resistance grid being formed by four force sensitive resistances connected in series in a bow-shaped configuration, and each horizontally arranged force sensitive resistance being connected in series via a heavily boron-doped short circuit bar; one end of the two resistance grids is commonly connected to one aluminum pressure foot, and a hole region exists between the three aluminum pressure feet; the three aluminum pressure feet are arranged in a triangular formation surrounding the hole region, and finally the entire strain gauge surface and sidewalls are encapsulated by the silicon nitride insulating passivation layer to form the full-frame closed hole structure; a silicon dioxide oxide layer is formed on both the upper surface and the lower surface of the high-resistance silicon substrate layer.

Further, the silicon dioxide oxide layer on the upper surface of the high-resistance silicon substrate layer and the silicon dioxide oxide layer on the lower surface thereof are identical in thickness.

For relatively thin semiconductor strain gauges according to the above technical solution, the silicon material itself has poor toughness and is prone to fracture under stress. By employing a full-frame closed structure for the entire strain gauge, each component of the strain gauge is interconnected and mutually supported, achieving structural stability. However, after interconnecting each component, stress differences exist between different parts. Therefore, by distributing the three aluminum pressure feet in a triangular formation in the center of the strain gauge and forming a hole region, a uniform and stable relief of stress differences between various components is effectively ensured at the planar center of the strain gauge, providing excellent stress dispersion. In particular, this prevents the full-frame closed strain gauge from developing cracks at the junctions of different components due to inconsistent thermal expansion/contraction under high or low temperatures, and also prevents the formation of cracks in the strain gauge itself under its inherent stress.

Secondly, by forming a silicon dioxide oxide layer on both the upper and lower surfaces of the high-resistance silicon substrate layer, stress matching can be structurally achieved. This allows the strain gauge to maintain stress balance in a free state, resulting in structural stability and stable resistance values. Furthermore, controlling the thickness of these silicon dioxide oxide layers to be consistent ensures the flatness of the strain gauge, thereby overcoming warpage caused by the mismatch in thermal expansion coefficients between the oxide layer and the silicon single crystal.

Further, both the front surface and the side surfaces of the force sensitive resistance are covered by the silicon nitride insulating passivation film.

The above technical solution isolates the force sensitive resistances from the external environment by covering their surfaces and sides with an insulating passivation film. This effectively protects the force sensitive resistances while reducing their susceptibility to external influences such as moisture, impurities, or mobile ions, simultaneously expanding the operating temperature range of the strain gauge.

Further, the internal leads of the strain gauge are composed of aluminum leads overlaid on the surface of a heavily boron-doped sub-nanocrystalline silicon thin film.

Further, the connection points between the force sensitive resistances are all connected via heavily boron-doped short circuit bars.

The above technical solution, by heavily boron-doping at the bends between each force sensitive resistances connection, achieves a reduction in the negative pressure resistance.

Further, the thickness of the strain gauge is 9-12 μm.

Further, the force sensitive resistance is composed of a sub-nanocrystalline silicon thin film, and the crystal nucleus size of the sub-nanocrystalline silicon thin film is between that of nanocrystalline silicon and polycrystalline silicon.

The above technical solution, by using a sub-nanocrystalline silicon thin film as the strain gauge resistor, eliminates the P-N junction structure inherent in traditional diffused silicon semiconductor strain gauges. This prevents the formation of a barrier region during high-temperature operation, resulting in stable impedance, a low temperature coefficient, and enabling the strain gauge to function at high temperatures. Additionally, the sub-nanocrystalline silicon thin film enhances the sensitivity of the strain gauge.

Further, the sub-nanocrystalline silicon thin film is grown on the surface of the silicon dioxide oxide layer by low-pressure chemical vapor deposition (LPCVD).

The above technical solution, by preparing the sub-nanocrystalline silicon thin film using LPCVD, allows for more uniform grain size in the resulting sub-nanocrystalline silicon and enables the growth of thinner films.

Further, a silicon dioxide oxide layer is formed on the upper layer of the force sensitive resistance.

The above technical solution, by forming a low-stress silicon dioxide oxide layer on the force sensitive resistances, protects the strain gauge resistor structure from contamination.

A method for preparing an ultra-thin full-frame high-temperature resistant semiconductor strain gauge, specifically including the following steps:
(1) taking a high-resistance silicon wafer with a thickness of 400-600 μm as a sacrificial layer, oxidizing the surface of the high-resistance silicon wafer, bonding another high-resistance silicon wafer onto the oxidized high-resistance silicon wafer, and thinning the upper high-resistance silicon wafer with a thinning machine to form a high-resistance silicon substrate layer;
(2) growing a silicon dioxide oxide layer on the surface of the high-resistance silicon substrate layer, and growing a sub-nanocrystalline silicon thin film by low-pressure chemical vapor deposition (LPCVD); then performing photolithography for the heavy boron doping region and ion implantation with the photoresist mask in place; after heavy boron ion implantation, performing annealing and redistribution; subsequently performing photolithography for the resistance region and ion implantation with the photoresist mask in place; after light boron ion implantation, performing annealing and redistribution;
(3) performing photolithography for the lead hole, depositing aluminum by evaporation, etching reversely, and alloying; then performing photolithography for the hole region and dry etching with the photoresist mask in place; performing deep ICP etching to a depth of 10 μm until self-termination, then removing the surface photoresist and depositing an insulating passivation layer; subsequently performing photolithography for the aluminum pressure feet and removing the surface photoresist; protecting the front side of the wafer, and etching away the sacrificial layer on the back side to form a semiconductor strain gauge with a thickness of 9-12 μm.

### Advantageous Effects

(1) For relatively thin semiconductor strain gauges according to the above technical solution, the silicon material itself has poor toughness and is prone to fracture under stress. By employing a full-frame closed structure for the entire strain gauge, each component of the strain gauge is interconnected and mutually supported, achieving structural stability. However, after interconnecting each component, stress differences exist between different parts. Therefore, by distributing the three aluminum pressure feet in a triangular formation in the center of the strain gauge and forming a hole region, a uniform and stable relief of stress differences between various components is effectively ensured at the planar center of the strain gauge, providing excellent stress dispersion. In particular, this prevents the full-frame closed strain gauge from developing cracks at the junctions of different components due to inconsistent thermal expansion/contraction under high or low temperatures, and also prevents the formation of cracks in the strain gauge itself under its inherent stress.

Secondly, by forming a silicon dioxide oxide layer on both the upper and lower surfaces of the high-resistance silicon substrate layer, stress matching can be structurally achieved. This allows the strain gauge to maintain stress balance in a free state, resulting in structural stability and stable resistance values. Furthermore, controlling the thickness of these silicon dioxide oxide layers to be consistent ensures the flatness of the strain gauge, thereby overcoming warpage caused by the mismatch in thermal expansion coefficients between the oxide layer and the silicon single crystal.

(2) The technical solution isolates the force sensitive resistances from the external environment by covering their surfaces and sides with an insulating passivation film. This effectively protects the force sensitive resistances while reducing their susceptibility to external influences such as moisture, impurities, or mobile ions, simultaneously expanding the operating temperature range of the strain gauge.

(3) The technical solution, by heavily boron-doping at the bends between each force sensitive resistances connection, achieves a reduction in the negative pressure resistance.

(4) The technical solution, by using a sub-nanocrystalline silicon thin film as the strain gauge resistor, eliminates the P-N junction structure inherent in traditional diffused silicon semiconductor strain gauges. This prevents the formation of a barrier region during high-temperature operation, resulting in stable impedance, a low temperature coefficient, and enabling the strain gauge to function at high temperatures. Additionally, the sub-nanocrystalline silicon thin film enhances the sensitivity of the strain gauge.

(5) The technical solution, by preparing the sub-nanocrystalline silicon thin film using LPCVD, allows for more uniform grain size in the resulting sub-nanocrystalline silicon and enables the growth of thinner films.

(6) The technical solution, by forming a low-stress silicon dioxide oxide layer on the force sensitive resistances, protects the strain gauge resistor structure from contamination.

### BRIEF DESCRIPTION OF ACCOMPANY DRAWINGS

FIG. 1 is a top view of the strain gauge according to the invention.

FIG. 2 is a cross-sectional view of the strain gauge according to the invention.

In the figures: 1 refers to the force sensitive resistance; 2 refers to the heavily boron-doped short circuit bar; 3 refers to the aluminum pressure foot; 4 refers to the silicon nitride insulating passivation layer; 5 refers to the hole region; 6 refers to the high-resistance silicon substrate layer; 7 refers to the silicon dioxide oxide layer; 8 refers to the silicon dioxide oxide layer; 9 refers to the silicon dioxide oxide layer.

### SPECIFIC EMBODIMENT OF THE INVENTION

The following describes the invention further in conjunction with specific embodiments, but the embodiments do not limit the invention in any form. Unless otherwise specified, the reagents, methods, and equipment used in the invention are conventional in the technical field.

Unless otherwise specified, reagents and materials used in the following embodiments are commercially purchased.

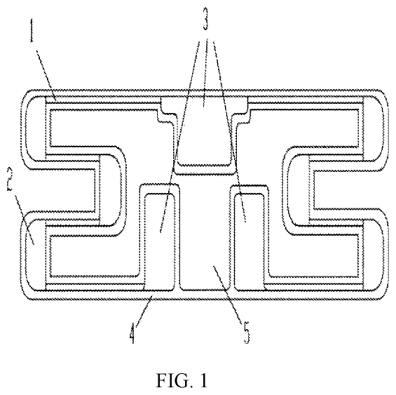

With reference to FIG. 1, the strain gauge with the full-frame closed hole structure comprises two resistance grids and three aluminum pressure feet; the two resistance grids are interconnected to form a half-bridge Wheatstone measurement circuit, each resistance grid being formed by four force sensitive resistances 1 connected in series in a bow-shaped configuration, and each horizontally arranged force sensitive resistance being connected in series via a heavily boron-doped short circuit bar 2; one end of the two resistance grids is commonly connected to one aluminum pressure foot 3, and a hole region 5 exists between the three aluminum pressure feet 3; the three aluminum pressure feet 3 are arranged in a triangular formation surrounding the hole region 5, and finally the entire strain gauge surface and sidewalls are encapsulated by the silicon nitride insulating passivation layer 4 to form the full-frame closed hole structure.

### Embodiment 1

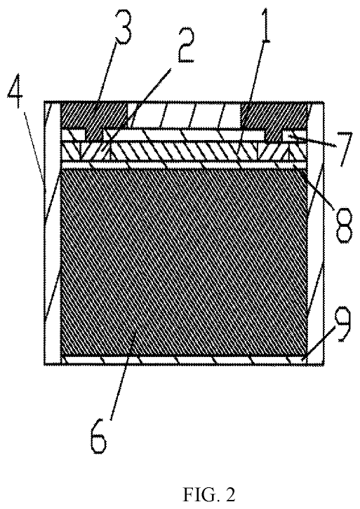

### With Reference to FIGS. 1-2:

taking a high-resistance silicon wafer with a thickness of 400 μm as a sacrificial layer, oxidizing the surface of the high-resistance silicon wafer to form a silicon dioxide oxide layer 9 with a thickness of 100 nm, bonding another high-resistance silicon wafer onto the oxidized high-resistance silicon wafer 9, and thinning the upper high-resistance silicon wafer to 9 μm with a thinning machine to form a high-resistance silicon substrate layer 6;
growing a silicon dioxide oxide layer 8 with a thickness of 100 nm on the surface of the high-resistance silicon substrate layer 6, and growing a sub-nanocrystalline silicon thin film force sensitive resistance 1 with a thickness of 600 nm on the silicon dioxide oxide layer 8 at 620° C. using LPCVD, each resistance grid being formed by four force sensitive resistances 1 connected in series in a bow-shaped configuration; then performing photolithography for the heavy boron doping short circuit bars 2, each horizontally arranged force sensitive resistance 1 being connected in series via a heavily boron-doped (1×10¹⁶ cm⁻³) short circuit bars 2; performing ion implantation with the photoresist mask in place; after heavy boron ion implantation, performing rapid annealing at 900° C. for 12 minutes with an RTP-200 furnace, combined with redistribution; then performing photolithography for the resistance region to obtain the resistance pattern, and performing light boron ion implantation (3×10¹⁵ cm⁻³) with the photoresist mask in place; after light boron ion implantation, performing annealing at 1000° C. for 30 minutes, combined with redistribution, to eliminate lattice defects; the crystal nucleus size of the sub-nanocrystalline silicon thin film is between that of nanocrystalline silicon and polycrystalline silicon;
finally, performing photolithography for the lead hole, depositing aluminum by evaporation with a thickness of 1.3 μm, etching reversely, and alloying for internal leads; then performing photolithography for the hole region 5 and dry etching with the photoresist mask in place; performing deep ICP etching to a depth of 10 μm until self-termination to obtain the hole structure; then removing the surface photoresist and depositing an silicon nitride insulating passivation layer 4; the silicon nitride insulating passivation layer 4 encapsulates and interconnects the strain gauge components to form the full-frame closed structure; then applying photoresist according to the pattern of the three aluminum pressure feet 3 arranged in a triangular formation surrounding the hole region 5; subsequently performing photolithography for the three aluminum pressure feet 3 and removing the surface photoresist; protecting the front side of the wafer, and etching away the sacrificial layer on the back side to form a semiconductor strain gauge with a full-frame closed hole structure and a thickness of 10 μm.

In the above process, the applied photoresist thickness is controlled at 1.5 μm, and the silicon dioxide oxide layer thickness is controlled at 100 nm.

### Embodiment 2

### With Reference to FIGS. 1-2:

taking a high-resistance silicon wafer with a thickness of 500 μm as a sacrificial layer, oxidizing the surface of the high-resistance silicon wafer to form a silicon dioxide oxide layer 9 with a thickness of 600 nm, bonding another high-resistance silicon wafer onto the oxidized high-resistance silicon wafer 9, and thinning the upper high-resistance silicon wafer to 10 μm with a thinning machine to form a high-resistance silicon substrate layer 6;
growing a silicon dioxide oxide layer 8 with a thickness of 600 nm on the surface of the high-resistance silicon substrate layer 6, and growing a sub-nanocrystalline silicon thin film force sensitive resistance 1 with a thickness of 100 nm on the silicon dioxide oxide layer 8 at 620° C. using LPCVD, each resistance grid being formed by four force sensitive resistances 1 connected in series in a bow-shaped configuration; then performing photolithography for the heavy boron doping short circuit bars 2, each horizontally arranged force sensitive resistance 1 being connected in series via a heavily boron-doped (1×10¹⁶ cm⁻³) short circuit bars 2; performing ion implantation with the photoresist mask in place; after heavy boron ion implantation, performing rapid annealing at 1000° C. for 15 minutes with an RTP-200 furnace, combined with redistribution; then performing photolithography for the resistance region to obtain the resistance pattern, and performing light boron ion implantation (3×10¹⁵ cm⁻³) with the photoresist mask in place; after light boron ion implantation, performing annealing at 1100° C. for 35 minutes, combined with redistribution, to eliminate lattice defects; the crystal nucleus size of the sub-nanocrystalline silicon thin film is between that of nanocrystalline silicon and polycrystalline silicon;
finally, performing photolithography for the lead hole, depositing aluminum by evaporation with a thickness of 1.2 μm, etching reversely, and alloying for internal leads; then performing photolithography for the hole region 5 and dry etching with the photoresist mask in place; performing deep ICP etching to a depth of 12 μm until self-termination to obtain the hole structure; then removing the surface photoresist and depositing an silicon nitride insulating passivation layer 4; the silicon nitride insulating passivation layer 4 encapsulates and interconnects the strain gauge components to form the full-frame closed structure; then applying photoresist according to the pattern of the three aluminum pressure feet 3 arranged in a triangular formation surrounding the hole region 5; subsequently performing photolithography for the three aluminum pressure feet 3 and removing the surface photoresist; protecting the front side of the wafer, and etching away the sacrificial layer on the back side to form a semiconductor strain gauge with a full-frame closed hole structure and a thickness of 12 μm.

In the above process, the applied photoresist thickness is controlled at 1.0 μm, and the silicon dioxide oxide layer thickness is controlled at 600 nm.

### Embodiment 3

### With Reference to FIGS. 1-2:

taking a high-resistance silicon wafer with a thickness of 600 μm as a sacrificial layer, oxidizing the surface of the high-resistance silicon wafer to form a silicon dioxide oxide layer 9 with a thickness of 600 nm, bonding another high-resistance silicon wafer onto the oxidized high-resistance silicon wafer 9, and thinning the upper high-resistance silicon wafer to 7 μm with a thinning machine to form a high-resistance silicon substrate layer 6;
growing a silicon dioxide oxide layer 8 with a thickness of 600 nm on the surface of the high-resistance silicon substrate layer 6, and growing a sub-nanocrystalline silicon thin film force sensitive resistance 1 with a thickness of 600 nm on the silicon dioxide oxide layer 8 at 620° C. using LPCVD, each resistance grid being formed by four force sensitive resistances 1 connected in series in a bow-shaped configuration; then performing photolithography for the heavy boron doping short circuit bars 2, each horizontally arranged force sensitive resistance 1 being connected in series via a heavily boron-doped (1×10¹⁶ cm⁻³) short circuit bars 2; performing ion implantation with the photoresist mask in place; after heavy boron ion implantation, performing rapid annealing at 800° C. for 10 minutes with an RTP-200 furnace, combined with redistribution; then performing photolithography for the resistance region to obtain the resistance pattern, and performing light boron ion implantation (3×10¹⁵ cm⁻³) with the photoresist mask in place; after light boron ion implantation, performing annealing at 900° C. for 25 minutes, combined with redistribution, to eliminate lattice defects; the crystal nucleus size of the sub-nanocrystalline silicon thin film is between that of nanocrystalline silicon and polycrystalline silicon;
finally, performing photolithography for the lead hole, depositing aluminum by evaporation with a thickness of 1.5 μm, etching reversely, and alloying for internal leads; then performing photolithography for the hole region 5 and dry etching with the photoresist mask in place; performing deep ICP etching to a depth of 12 μm until self-termination to obtain the hole structure; then removing the surface photoresist and depositing an silicon nitride insulating passivation layer 4; the silicon nitride insulating passivation layer 4 encapsulates and interconnects the strain gauge components to form the full-frame closed structure; then applying photoresist according to the pattern of the three aluminum pressure feet 3 arranged in a triangular formation surrounding the hole region 5; subsequently performing photolithography for the three aluminum pressure feet 3 and removing the surface photoresist; protecting the front side of the wafer, and etching away the sacrificial layer on the back side to form a semiconductor strain gauge with a full-frame closed hole structure and a thickness of 12 μm.

In the above process, the applied photoresist thickness is controlled at 1.9 μm, and the silicon dioxide oxide layer thickness is controlled at 600 nm.

### Embodiment 4

### With Reference to FIGS. 1-2:

This embodiment is the same as Embodiment 1, except that the sequence of heavy boron ion implantation and light boron ion implantation is reversed (light boron first, then heavy boron). Other conditions remained unchanged.

### Comparative Embodiment 1

### With Reference to FIGS. 1-2:

This comparative embodiment is the same as Embodiment 1, except that the step of performing photolithography for the hole region is omitted. Other conditions remained unchanged.

### Comparative Embodiment 2

### With Reference to FIGS. 1-2:

This comparative embodiment is the same as Embodiment 1, except that the thickness of the upper surface silicon dioxide oxide layer 8 on the high-resistance silicon substrate layer is different from the thickness of the lower surface silicon dioxide oxide layer 9. Other conditions remained unchanged.

### Comparative Embodiment 3

### With Reference to FIGS. 1-2:

This comparative embodiment is the same as Embodiment 1, except that:
taking a high-resistance silicon wafer with a thickness of 400 μm as a sacrificial layer, oxidizing the surface of the high-resistance silicon wafer to form a silicon dioxide oxide layer 9 with a thickness of 100 nm, bonding another high-resistance silicon wafer onto the oxidized high-resistance silicon wafer 9, and thinning the upper high-resistance silicon wafer to 9 μm with a thinning machine to form a high-resistance silicon substrate layer 6;
growing a silicon dioxide oxide layer 8 with a thickness of 100 nm on the surface of the high-resistance silicon substrate layer 6, and growing a sub-nanocrystalline silicon thin film force sensitive resistance 1 with a thickness of 600 nm on the silicon dioxide oxide layer 8 at 620° C. using LPCVD, each resistance grid being formed by four force sensitive resistances 1 connected in series in a bow-shaped configuration; then performing photolithography for the heavy boron doping short circuit bars 2, each horizontally arranged force sensitive resistance 1 being connected in series via a heavily boron-doped (1×10¹⁶ cm⁻³) short circuit bars 2; performing ion implantation with the photoresist mask in place; after heavy boron ion implantation, performing rapid annealing at 900° C. for 12 minutes with an RTP-200 furnace, combined with redistribution; then performing photolithography for the resistance region to obtain the resistance pattern, and performing light boron ion implantation (3×10¹⁵ cm⁻³) with the photoresist mask in place; after light boron ion implantation, performing annealing at 1000° C. for 30 minutes, combined with redistribution, to eliminate lattice defects; the crystal nucleus size of the sub-nanocrystalline silicon thin film is between that of nanocrystalline silicon and polycrystalline silicon;
finally, performing photolithography for the lead hole, depositing aluminum by evaporation with a thickness of 1.3 μm, etching reversely, and alloying for internal leads; then performing photolithography for the hole region 5 and dry etching with the photoresist mask in place; performing deep ICP etching to a depth of 10 μm until self-termination to obtain the hole structure; then removing the surface photoresist and depositing an silicon nitride insulating passivation layer 4, to form a fault between the two lower horizontally arranged aluminum pressure feet 3 in a “ [symbol] ”-shape configuration, failing to achieve a full-frame closed connection; then applying photoresist according to the pattern of the three aluminum pressure feet 3 arranged in a triangular formation surrounding the hole region 5; subsequently performing photolithography for the three aluminum pressure feet 3 and removing the surface photoresist; protecting the front side of the wafer, and etching away the sacrificial layer on the back side to form a semiconductor strain gauge with a full-frame closed hole structure and a thickness of 10 μm.

In the above process, the applied photoresist thickness is controlled at 1.5 μm, and the silicon dioxide oxide layer thickness is controlled at 100 nm.

Strain gauges obtained from Embodiments 1~4 and Comparative Embodiments 1-3 are fabricated into glass micro-fused pressure sensors for performance testing. Specific test methods and results are as follows.

Zero Temperature Coefficient: the output voltage of the sensor under zero pressure is tested at 25° C., 100° C., 160° C., 170° C., 180° C., 190° C., and 200° C. The zero temperature coefficient is calculated.

Sensitivity Temperature Coefficient: the output voltage of the sensor under zero pressure and full pressure is tested at 25° C., 100° C., 160° C., 170° C., 180° C., 190° C., and 200° C. The sensitivity temperature coefficient is calculated.

Specific test results are shown in Table 1 below:

TABLE 1
Product Performance Test Results

| | Sensitivity Temperature | Zero Temperature |
|---|---|---|
| | Coefficient (%/° C.) | Coefficient (%/° C.) |
| Embodiment 1 | −0.023 | −0.023 |
| Embodiment 2 | −0.025 | −0.026 |
| Embodiment 3 | −0.026 | −0.023 |
| Embodiment 4 | −0.027 | −0.024 |
| Comparative | −0.050 | −0.032 |
| Embodiment 1 | | |
| Comparative | −0.045 | −0.033 |
| Embodiment 2 | | |
| Comparative | −0.035 | −0.030 |
| Embodiment 3 | | |

As shown in the test results of Table 1, the thickness of the ultra-thin full-frame high-temperature resistant semiconductor strain gauge obtained by the invention is only about 10 μm. To ensure the flatness of the strain gauge, the thickness of the oxide layers grown on the front and back surfaces should be consistent. This overcomes warpage caused by the mismatch in thermal expansion coefficients between the oxide layer and the silicon single crystal. Because the strain gauge uses a full-frame structure and incorporates a stress dispersion design, the stress on the strain gauge is balanced and its structure is stable. The strain gauge exhibits high yield after etching and separation, with a finished product yield exceeding 90%. The polysilicon resistance strips have silicon dioxide isolation at the bottom, and both the upper surface and sidewalls have an insulating passivation layer structure. This effectively solves the high-temperature leakage current problem common in PN junction structures. The strain gauge can operate normally at 180° C. and possesses excellent characteristics for stable operation in high-temperature environments. Actual tests show that sensors made using this strain gauge via the micro-fusion process achieve an uncompensated zero temperature coefficient and sensitivity temperature coefficient of −0.023%/° C. at 180° C. high temperature.

The above embodiments are preferred implementations of the invention, but the implementations of the invention are not limited by the above embodiments. Any changes, modifications, substitutions, combinations, or simplifications made without departing from the spirit and principle of the invention shall be deemed equivalent replacement methods and are all included within the protection scope of the invention.

1. An ultra-thin full-frame high-temperature resistant semiconductor strain gauge, wherein the strain gauge adopts a full-frame closed hole structure and comprises a high-resistance silicon substrate layer, a silicon dioxide oxide layer, two resistance grids, three aluminum pressure feet, and a silicon nitride insulating passivation film;
the two resistance grids are interconnected to form a half-bridge Wheatstone measurement circuit, each resistance grid being formed by four force sensitive resistances connected in series in a bow-shaped configuration, and each horizontally arranged force sensitive resistance being connected in series via a heavily boron-doped short circuit bar; one end of the two resistance grids is commonly connected to one aluminum pressure foot, and a hole region exists between the three aluminum pressure feet; the three aluminum pressure feet are arranged in a triangular formation surrounding the hole region, and finally the entire strain gauge surface and sidewalls are encapsulated by the silicon nitride insulating passivation layer to form the full-frame closed hole structure; a silicon dioxide oxide layer is formed on both the upper surface and the lower surface of the high-resistance silicon substrate layer.

2. The ultra-thin full-frame high-temperature resistant semiconductor strain gauge of claim 1, wherein the silicon dioxide oxide layer on the upper surface of the high-resistance silicon substrate layer and the silicon dioxide oxide layer on the lower surface thereof are identical in thickness.

3. The ultra-thin full-frame high-temperature resistant semiconductor strain gauge of claim 1, wherein both the front surface and the side surfaces of the force sensitive resistance are covered by the silicon nitride insulating passivation film.

4. The ultra-thin full-frame high-temperature resistant semiconductor strain gauge of claim 1, wherein the internal leads of the strain gauge are composed of aluminum leads overlaid on the surface of a heavily boron-doped sub-nanocrystalline silicon thin film.

5. The ultra-thin full-frame high-temperature resistant semiconductor strain gauge of claim 1, wherein the connection points between the force sensitive resistances are all connected via heavily boron-doped short circuit bars.

6. The ultra-thin full-frame high-temperature resistant semiconductor strain gauge of claim 1, wherein the thickness of the strain gauge is 9-12 μm.

7. The ultra-thin full-frame high-temperature resistant semiconductor strain gauge of claim 1, wherein the force sensitive resistance is composed of a sub-nanocrystalline silicon thin film, and the crystal nucleus size of the sub-nanocrystalline silicon thin film is between that of nanocrystalline silicon and polycrystalline silicon.

8. The ultra-thin full-frame high-temperature resistant semiconductor strain gauge of claim 7, wherein the sub-nanocrystalline silicon thin film is grown on the surface of the silicon dioxide oxide layer by low-pressure chemical vapor deposition (LPCVD).

9. The ultra-thin full-frame high-temperature resistant semiconductor strain gauge of claim 1, wherein a silicon dioxide oxide layer is formed on the upper layer of the force sensitive resistance.

10. A method for preparing an ultra-thin full-frame high-temperature resistant semiconductor strain gauge, specifically including the following steps:
(1) taking a high-resistance silicon wafer with a thickness of 400-600 μm as a sacrificial layer, oxidizing the surface of the high-resistance silicon wafer, bonding another high-resistance silicon wafer onto the oxidized high-resistance silicon wafer, and thinning the upper high-resistance silicon wafer with a thinning machine to form a high-resistance silicon substrate layer;
(2) growing a silicon dioxide oxide layer on the surface of the high-resistance silicon substrate layer, and growing a sub-nanocrystalline silicon thin film by low-pressure chemical vapor deposition (LPCVD); then performing photolithography for the heavy boron doping region and ion implantation with the photoresist mask in place; after heavy boron ion implantation, performing annealing and redistribution; subsequently performing photolithography for the resistance region and ion implantation with the photoresist mask in place; after light boron ion implantation, performing annealing and redistribution;
(3) performing photolithography for the lead hole, depositing aluminum by evaporation, etching reversely, and alloying; then performing photolithography for the hole region and dry etching with the photoresist mask in place; performing deep ICP etching to a depth of 10 μm until self-termination, then removing the surface photoresist and depositing an insulating passivation layer; subsequently performing photolithography for the aluminum pressure feet and removing the surface photoresist; protecting the front side of the wafer, and etching away the sacrificial layer on the back side to form a semiconductor strain gauge with a thickness of 9-12 μm.
